(19) United States
(12) Patent Application Publication
(10) Pub. No.: US 2001/0048373 A1
(43) Pub. Date: Dec. 6, 2001

(54) Home automation identification system

(76) Inventor: David Sandelman, Chatham, NJ (US)

Correspondence Address: Barry E. Negrin, Esq., Levisohn, Lerner, Berger & Langsam, Suite 2400, 757 Third Avenue, New York, NY, 10017, US

(21) Appl. No.: 09/761,503

(22) Filed: Jan. 17, 2001

Related U.S. Application Data
(60) Provisional application No. 60/176,846, filed on Jan. 19, 2000.

(51) Int. Cl. H04Q 5/22

(52) U.S. Cl. 340/825.52; 340/10.42; 340/10.52

(57) ABSTRACT

A system for identifying smart appliances in a given family of home automation. The system includes an inductive transceiver connected to an address register of an appliance and a portable inductive data holder also having an address register. The portable data holder is designed to be placed near one appliance having a transmitter so that the identification information of the first appliance may be inductively received into the address register of the portable device. When a new smart appliance is brought home and it is desired to incorporate the new appliance into the existing home automation system, the portable device is then held near the new device so that the address stored in the portable device's address registered is inductively transmitted to the address register in the new appliance. The portable device acts like a “syringe” which “injects” the identification code of the first appliance into the second appliance.

### RELATED APPLICATIONS

This application claims benefit of U.S. Provisional Patent Application No. 60/176,846 filed Jan. 19, 2000.

### BACKGROUND OF THE INVENTION

1. Field of the Invention

The invention relates to home automation, and more particularly relates to a system for coordinating the information and activities of several appliances in an efficient manner.

2. Description of the Related Art

A home appliance is typically referred to as a “smart appliance” when it contains a control system that has the capability to interact, e.g., exchange information, with other appliances. One of the major issues that need be addressed with smart appliances in home automation is the problem of membership or identification. Membership, is the family or communal relationship that exists between the smart appliances in a home. There are many means by which appliances can communicate; through the air via sound waves ranging in frequency from subsonic to ultrasonic, over the power wires via a power line carrier, via electromagnetic waves in any portion of the spectrum, and many others.

FIG. 1 shows a television (3), a toaster (4), a home security system (5), and a coffee maker (6) all located within a home. The television (3) is capable of transmitting the time of day by means of a power line carrier signal over the power lines (1), as well as transmitting the time of day through the air via a radio frequency signal (2). The toaster (4) and the coffee maker (6) receive the time of day signal over the power line (1) and the security system (5) receives the time of day signal through the air via the radio frequency (RF) signal (2). By communicating the time of day signal among appliances in these ways it is no longer necessary to set each of the clocks on these appliances. Another example of the utilization of information being communicated between appliances can be realized when a homeowner leaves his or her home and sets the security system (5) to the armed, “home unoccupied” mode. The security system (5) can communicate to other appliances such as the toaster (4) and the coffee maker (6) that the home is unoccupied and that these appliances should be turned off. Such communication is generally accomplished by sending information to the television (3) (the only appliance in FIG. 1 with both an RF link and a power line carrier link) which, in turn, forwards the information to the toaster and the coffee maker. In an alternative arrangement (not shown), the security system (5) may be linked to the power lines 1 via a power line carrier in the same manner as the television (3).

Many of the means by which these various appliances may communicate are not limited to the property line of a home; information transmitted by an appliance in one home may be received by appliances in nearby homes. FIG. 2 shows two sets of appliances in two neighboring homes. Because the two homes are located next to one another, they share a common utility transformer supplying the power to the two homes. At the point where the two homes connect to the transformer, an inadvertent interconnection (1b) is formed between the two homes allowing communications over the power line to take place between the appliances in one home with the appliances in the neighboring home. An inadvertent interconnection (2a) between the appliances that communicate via RF in the two homes can also take place when the physical proximity of the two homes is within the RF range of the transceivers within the appliances. Inadvertent interconnections between homes is not desirable, as the transmissions of one home's devices can affect the functionality of another home's devices. As an example, if the person in a first home sets his security system, the coffee maker in the neighboring house may be erroneously deactivated.

In order for appliances to communicate with one another and not interfere with other appliances in neighboring homes they must become members of a particular system in a home, the units need to be bound to one another by some means. In other words, there must exist among the appliances a common identification system that enables an appliance of one domicile to recognize other appliances from the same domicile but ignore instructions or information from appliances of a different domicile. The most common method used today involves the user setting a particular pattern of switches or address code on each appliance to both give the unit a unique address as well as a group address so that it can communicate with other appliances within the home or group. The most common home appliance that utilizes this method of binding and membership is the garage door opener. The homeowner sets a unique pattern of switches on both the hand held transmitter and the receiver on the door opener. The pattern of switches forms a unique code that allows the pair of devices in one home to communicate without affecting a neighbor's system, which would mean one home owner would not open a neighbor's garage door.

If a user of the appliances incorrectly sets the address switch pattern of an appliances with in a group, that appliance will not be able to communicate with other appliances in its intended group, or possibly interfere with the communication of a neighbors group of appliances. Using the garage door as an example, and incorrect setting of the address on the handheld transmitter as compared to the address set on the door opener would mean that the opener will not operate the door, and possibly may operate a neighbor's door. Such a system places too much responsibility in consumers who typically are interested in devices that are easy to use and do not require significant user input in order to function correctly.

Another method of identifying the members of a group appliance involves putting an existing appliance in the home in a talk or broadcast mode and putting a new appliance that is to become a member of the existing group in a listen or receiving mode. The broadcasting appliance broadcasts identification information that is to be received by any appliances in the receiving mode. The information is typically an ID code which, when used for inter-appliance communication, is transmitted along with instructions, information, or messages. Messages or information carrying the proper ID code will be heeded and other messages without the proper ID code will be ignored. A method similar to this is described in U.S. Pat. No. 5,291,193 to Isobe et al., the teachings of which are incorporated by reference herein. If a neighbor is performing the same operation at the same time, it is possible that a user's appliance may become a member of the user's neighbor's group or the user's neighbor's appliance may become a member of the user's group. In these types of systems, safeguards have been employed to reduce the likelihood of such an occurrence. Time limits are set on how long an appliance may be in the talk or listen mode. This time limit then requires the homeowner to go to one appliance put it in the talk mode, then go over to the next appliance and put it in the listen mode before the first appliance times out and is no longer in the talk mode. This method can be difficult to perform if the domicile in question is large and requires more time to traverse than is permitted in the talk or listen modes of the devices. Also, as the number of smart appliances increases and more and more homes are equipped with home automation systems, interference between neighboring domiciles will become much more frequent. ‘Other methods employ the use of a central control that must have the list of all member appliances’ unique address numbers entered into a table. This method requires the homeowner to enter a list of addresses of the appliances that are to communicate with each other. This can be time consuming, and if errors are made during the data entry process, the system might not properly work.

### SUMMARY OF THE INVENTION

Accordingly, it is an object of the invention to provide a simple and easy-to-use method and system for identifying smart appliances in home automation.

It is another object of the invention to provide a method and system for identifying smart appliances in home automation to the exclusion of appliances in a different domicile.

The above and other objects are achieved by the invention which is a system for identifying appliances. The system includes an inductive transceiver connected to an address register of an appliance and a portable inductive data holder (e.g., receiver/transmitter) also having an address register. The portable data holder is designed to be placed near one appliance having a transmitter so that the identification information of the first appliance is inductively received into the address register of the portable device. When a new smart appliance is brought home and it is desired to incorporate the new appliance into the existing home automation system, the portable device is then held near the new device so that the address stored in the portable device's address registered is inductively transmitted to the address register in the new appliance. The portable device acts like a “syringe” which “injects” the identification code of the first appliance into the second appliance.

The portable device is preferably hand-held. In one embodiment, one end of the portable device houses the receiver and the other end of the device houses the transmitter. Both the transmitter and the receiver are connected to an address register. Thus, when one is using the hand-held device to receive identification information from an appliance, the receiver end of the device is brought close to the induction transceiver of the appliance. Similarly, when one must transmit identification information from the portable device to an appliance, the transmitter end is brought close to the induction receiver of the appliance. In another embodiment, the hand-held device is provided with a switch for switching between a receiving mode and a transmitting mode. In the transmitting mode, the receiver is disabled and the transmitter is enabled, allowing the contents of the address register to be transmitted to an appliance. In the receiving mode, the receiver is enabled and the transmitter is disabled, allowing the portable device to accept the identification information from an appliance into its address register. In a third embodiment, the hand-held device possesses only an inductive transmitter and is preprogrammed with an identification code in its address register at the time of manufacture.

The invention also includes the method of identifying home automation, e.g., smart appliances, by use of the inventive system.

It is the intent of this invention to both eliminate the issues outlined above with existing systems, as well as make the process of binding appliances into a group in a home easy to do, secure, without error, and reliable.

### BRIEF DESCRIPTION OF THE DRAWINGS

FIG. 1 is a schematic view of a conventional home automation system.

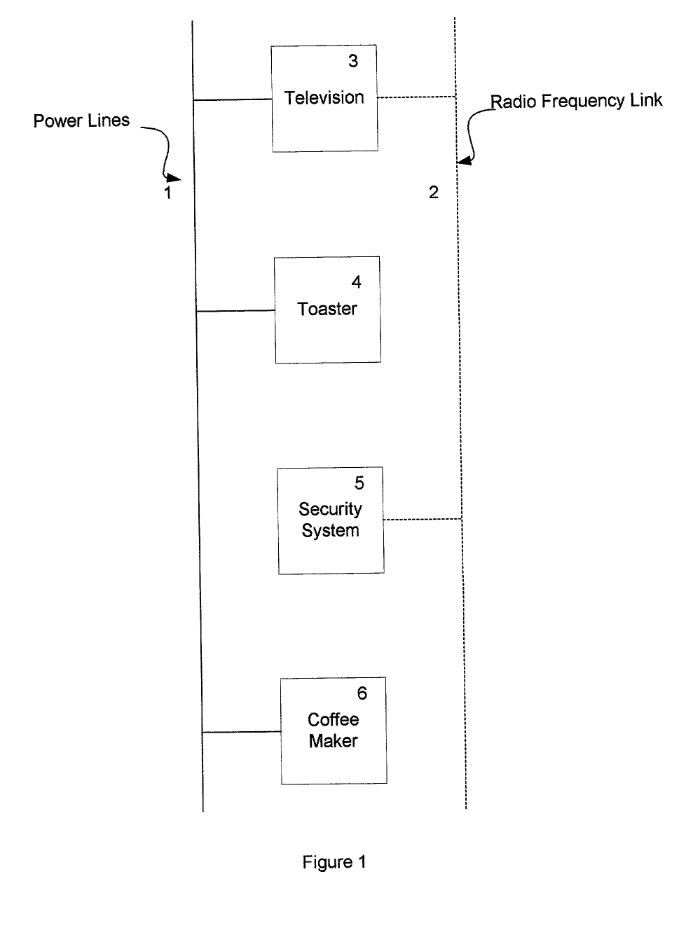

FIG. 2 is a schematic view of two conventional home automation systems in close proximity to each other.

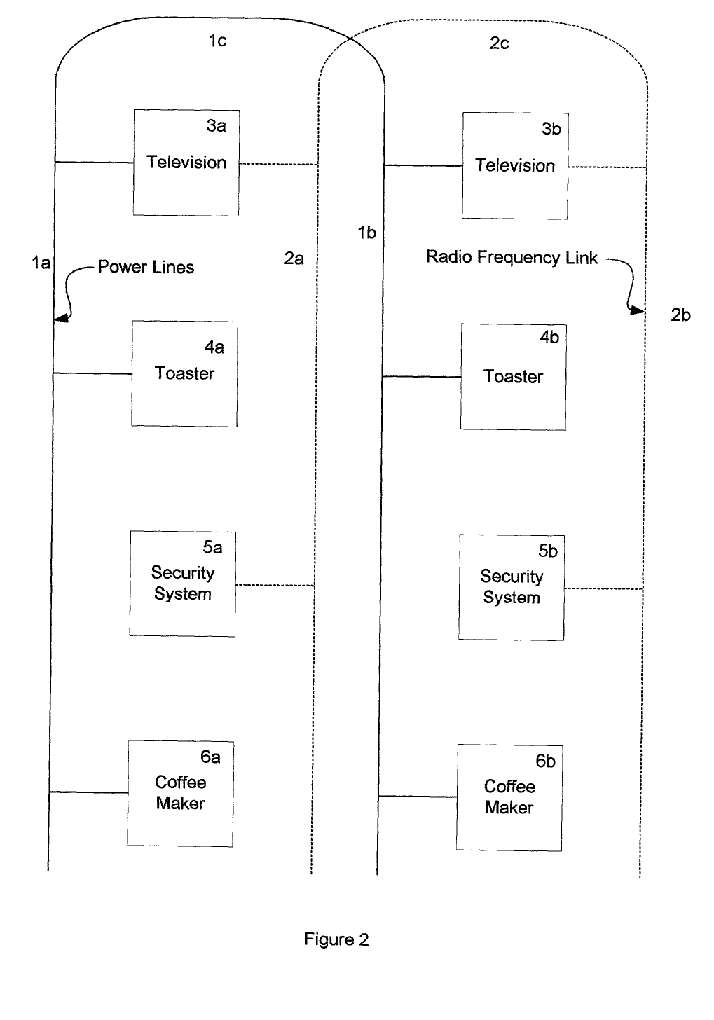

FIG. 3 is a schematic view of a conventional “smart” television as part of a home automation system.

FIG. 4 is a schematic view of a conventional “smart” toaster as part of a home automation system.

FIG. 5 is a schematic view of a toaster as part of a home automation system in accordance with the system of the instant invention.

FIG. 6 is a schematic view of one embodiment of the portable identification information vector in accordance with the instant invention.

FIG. 7 is a schematic view of a second embodiment of the portable identification information vector in accordance with the instant invention.

### DETAILED DESCRIPTION OF THE PREFERRED EMBODIMENTS

Description of the inventive system shall now be given with reference to the figures, which are exemplary in nature and do not constitute limitations on the invention.

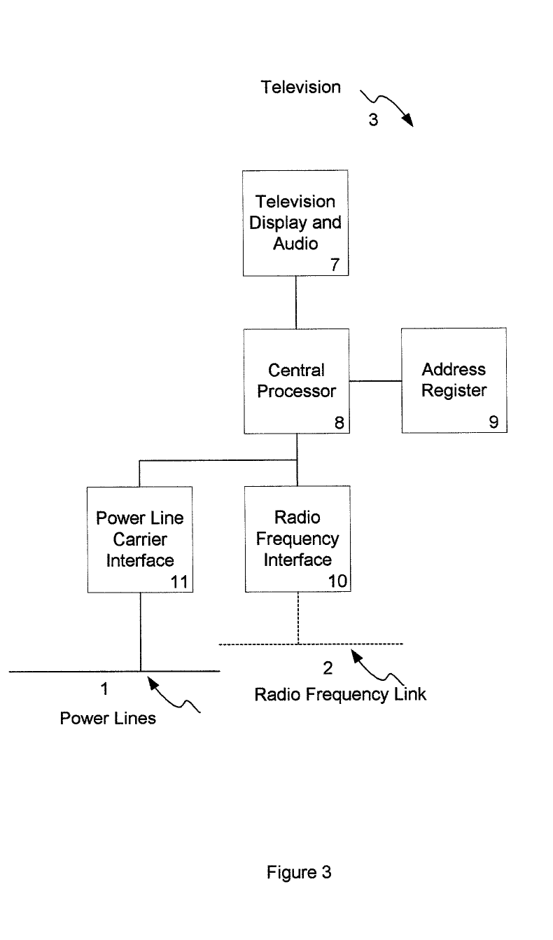

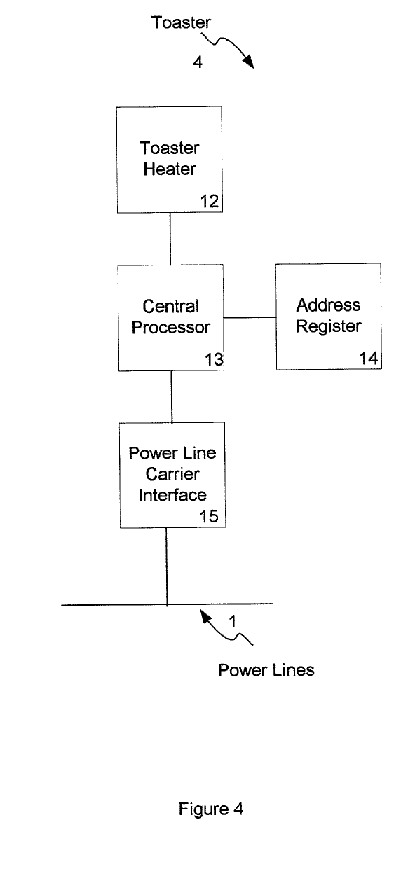

FIG. 3 is a schematic for a conventional smart appliance television; all of the required subsystems that make up a television, from audio and video reception to the display and audio output devices, are shown as a single element (7). The television also contains a central processor (8) that may either be shared with the television subsystems or be used only for inter-appliance communications. The central processor is connected to a power line carrier interface (11) and a radio frequency interface (10). These two interfaces are used to detect data on their respective networks and provide it to the central processor (8) to evaluate and act upon if required. The address register (9) contains the home address for which this appliance is a member of. The register may be in the form of an array of switches that are set to a particular pattern, or an area in memory that contains the membership address. FIG. 4 depicts a conventional smart toaster with the functional elements required to make toast, contained in a single sub-system (12). The toaster also contains a central processor (13), a power line carrier interface (15), and an address register (14).

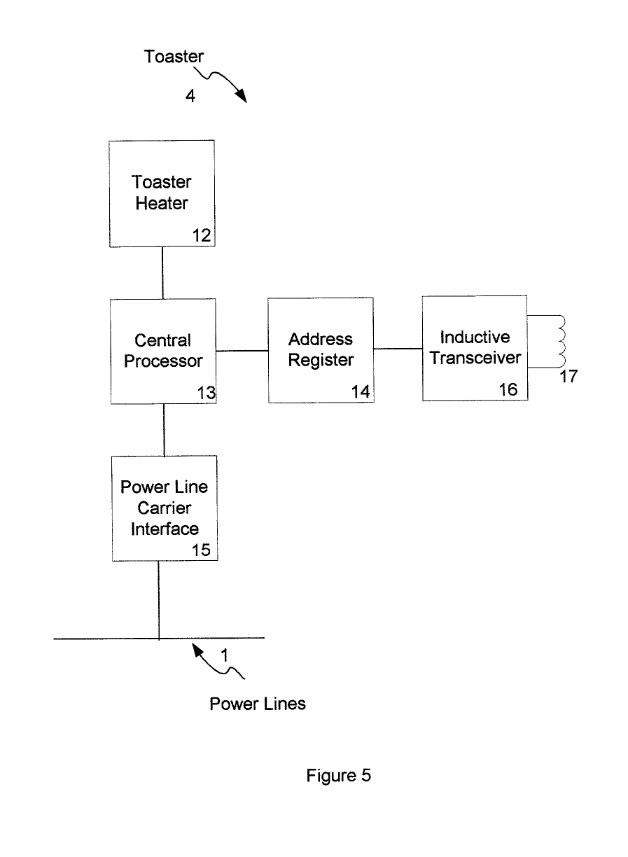

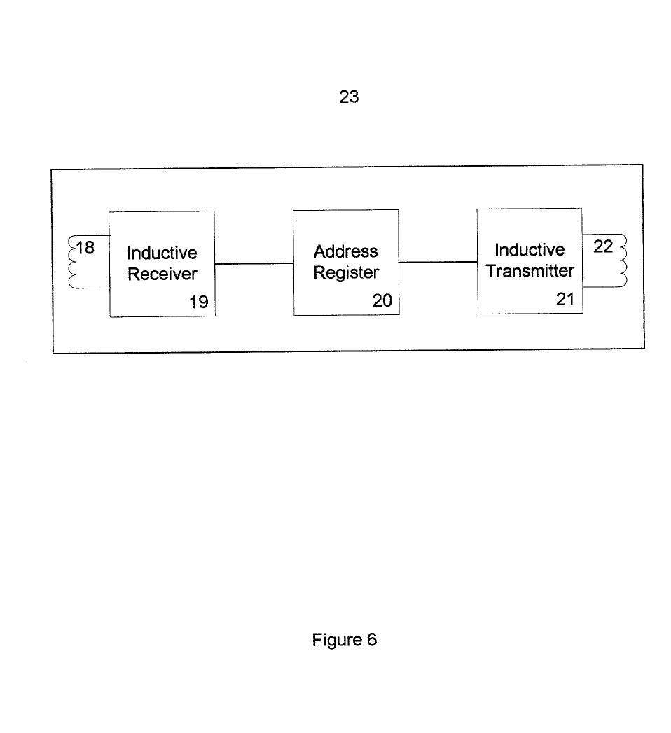

As shown in FIG. 5, the invention requires each smart appliance that has the capability to communicate with other smart appliances to be equipped with a short range inductively coupled transceiver (16) that is connected to a closed coil antenna (17). Similar types of transmitters can be found in use with smart card technologies. A small hand-held device or wand (23) is schematically illustrated in FIG. 6. Wand (23), approximately the size of a fountain pen, contains a receiver (19) connected to a closed coil antenna at one end (18), and a transmitter (21) connected to a closed coil antenna (22) at the opposite end. The transmitter and receiver are each connected to a common memory device or address register (20). Each of these hand-held wands can be analogous to an “information syringe.” Address register (20) may be pre-filled with a unique address at the time it is manufactured. When a homeowner purchases his first smart appliance, he holds the antenna (22) of the hand-held wand (23) next to the antenna (17) of the appliance (4) and transfers the address code found in the hand-held wand (23) into the appliance via the inductive link formed between the two inductive antennae. When the homeowner purchases subsequent smart appliances, the homeowner takes the same hand-held wand (23) used on the first appliance (4) and transfers the unique address into the new smart appliance. By doing this, all of the smart appliances become members of this unique address code found in the hand-held wand (23). This process can be repeated as many times as necessary for each new appliance that requires becoming a member of the home network.

The hand-held wand (23) may have an internal power source such as a battery but does not require an internal source of power. During the period of time when data is being transferred either in or out of the hand-held wand (23) the required power for the hand-held wand (23) would come from the power source in the appliance and be communicated between the closed coil antenna in the appliance (17) and the closed coil antenna (22) of the transmitter (21) or the closed coil antenna (18) of the receiver (19), depending on the direction of data transfer.

The hand-held wand (23) is also capable of obtaining a copy of an appliance's address code found in the appliance's address register (14). The hand-held wand can then be brought over to another smart appliance and the code copied from the first appliance can now be transferred into the second appliance. This function would be used if a homeowner has lost their original hand-held wand that contains the original address code and needs to add new smart appliances to their network. Depending on the end of the hand-held wand the user uses to touch the appliance will determine the direction in which the data will flow; either from the wand into the appliance or from the appliance into the wand.

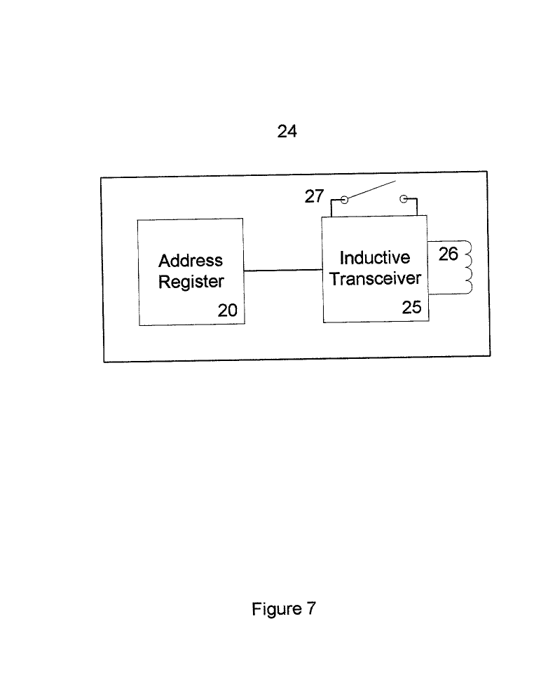

FIG. 7 shows a variation of the hand-held wand (24) that only has an antenna (26) located in one end that is connected to a transceiver (25). The direction of data flow is determined by the position of a switch (27) located in the hand-held wand (24). In one position data is moved from the appliance into the hand-held wand, in the other position the data is moved from the hand-held wand into the appliance.

In a simpler embodiment, the wand (23) or (24) may be provided with only the ability to transmit identification information to appliances. In this embodiment, the wand is provided with an identification code at the time of manufacture and only possesses a transmitter. The appliances would receive the code from the wand as above. This embodiment would prevent a consumer from inadvertently erasing the identification code of his “syringe” when he was trying to download its code onto his appliances. Such an accidental erasure is possible if the consumer points the wrong end of the wand (23) at the appliance in the first embodiment or has switch 27 in the wrong position in wand 24 of the second embodiment. The flexibility of the system is more limited by using this embodiment, however the system becomes more “foolproof.”

Regardless of which embodiment of hand-held device is employed, the invention will make it easy for a consumer who has purchased a smart television, home security system, smart toaster, coffee maker, or any other smart appliance, to become a member and communicate with other smart appliances found in and around a home without interacting or interfering with a neighbor's smart appliances. By touching the hand-held device to (or waving it near) existing smart appliances and then touching new smart appliances with the hand-held wand or device, the new appliances become members of that home's automation system. The toaster and coffee maker will now know when the home security is set to the away mode indicating that no one is home and that they should deactivate if left on. There will no longer be the problem of the toaster or coffee maker in one house being shut off because they “overheard” the security system in a nearby house over the power lines or via RF signals broadcast that it is in the away mode.

The direction in which codes can be transferred in or out of a particular appliance can be disabled or locked by the owner of the appliance for security. The central processor found in each appliance controls this functionality. Once an appliance has its ability to receive a new code shut off, this appliance cannot be used as a member of a different group, rendering it non-functional if stolen.

Having described the invention with regard to specific embodiments, it is to be understood that the above description is not meant as a limitation excluding such further variations or modifications as may be apparent or may suggest themselves to those skilled in the art. For example, the hand-held portable device is described as being a wand, i.e., a roughly cylindrical shape, however any convenient geometry may be employed. For example, the hand-held device may be shaped like a conventional remote control, or it may have a pistol-type grip, or it may be shaped like a pager, or it may be mounted on a wristband, a pendant, etc.

What is claimed is:

1. A system for identifying the constituent smart appliances in a given home automation family, each of the smart appliances having an address register for containing identification information, the system comprising:
an inductive transceiver connected to an address register of a first constituent appliance, the address register having identification information; and
a portable inductive data holder having a portable address register adapted to be placed near said inductive transceiver,
wherein the identification information of the first constituent appliance is inductively received into said portable address register of said portable inductive data holder when said portable inductive data holder is placed near said inductive transceiver.

2. A system according to claim 1, wherein the identification information received into said portable address register is inductively transmittable to an address register of a second appliance when said portable inductive data holder is placed near a second inductive transceiver connected to a second address register of the second appliance, thereby making the second appliance a second constituent appliance.

3. A system according to claim 1, wherein said portable inductive data holder is hand-held.

4. A system according to claim 2, said portable inductive data holder comprises a first end, a second end, a receiver, and a transmitter, wherein said first end of said portable inductive data holder houses said receiver and said second end houses said transmitter, wherein both of said transmitter and said receiver are connected to said portable address register.

5. A system according to claim 4, wherein when said first end is brought close to said induction transceiver of an appliance, identification information is inductively transmitted from said inductive transmitter to said receiver and placed in said portable address register, and when said second end is brought close to said induction receiver of an appliance, identification information is inductively transmitted from said portable address register to an address register of the appliance via said transmitter and said inductive transceiver.

6. A system according to claim 2, wherein said portable inductive data holder further comprises a receiver, a transmitter, and a switch connected to said receiver and said transmitter movable from a first position to a second position for switching between a receiving mode and a transmitting mode, wherein when said switch is in said first position, said receiver is disabled and said transmitter is enabled allowing contents of said portable address register to be transmitted to an appliance, and wherein when said switch is in said second position, said receiver is enabled and said transmitter is disabled allowing the portable device to accept identification information from an appliance into said portable address register.

7. A system for identifying the constituent smart appliances in a given home automation family, each of the smart appliances having an address register for containing identification information, the system comprising:
a plurality of inductive transceivers each respectively connected to an address register of said appliances, the address register capable of receiving identification information; and
a portable inductive data holder having a portable address register adapted to be placed near said inductive transceiver, said portable inductive data holder including an inductive transmitter, said portable address register being pre-programmed at manufacture with an identification code in said portable address register,
wherein said identification code pre-programmed into said portable address register is inductively transmittable to an address register of an appliance when said portable inductive data holder is placed near a second inductive transceiver connected to a second address register of the second appliance, thereby making the second appliance a constituent appliance.

8. A home automation system comprising:
a plurality of smart appliances, each of said smart appliances respectively having an address register for containing identification information;
a plurality of inductive transceivers each respectively connected to one of said address registers; and
a portable inductive data holder having a portable address register adapted to be placed near each of said inductive transceivers,
wherein first identification information of a first of said appliances is inductively received into said portable address register of said portable inductive data holder when said portable inductive data holder is placed near said inductive transceiver.

9. A system according to claim 8, wherein said first identification information received into said portable address register is inductively transmittable to at least one of said address registers of at least a second of said appliances, thereby making said second appliance have the same identification information as said first of said appliances.

10. A system according to claim 8, wherein said portable inductive data holder is hand-held.

11. A system according to claim 9, said portable inductive data holder comprising a first end, a second end, a receiver, and a transmitter, wherein said first end of said portable inductive data holder houses said receiver and said second end houses said transmitter, wherein both of said transmitter and said receiver are connected to said portable address register.

12. A system according to claim 11, wherein when said first end is brought close to one of said induction transceivers of one of said smart appliances, identification information is inductively transmitted from said inductive transmitter to said receiver and placed in said portable address register of said portable inductive data holder, and when said second end is brought close to one of said induction receivers of one of said smart appliances, identification information is inductively transmitted from said portable address register to said address register of said one of said appliance via said transmitter and said inductive transceiver.

13. A system according to claim 9, wherein said portable inductive data holder further comprises a receiver, a transmitter, and a switch connected to said receiver and said transmitter movable from a first position to a second position for switching between a receiving mode and a transmitting mode, wherein when said switch is in said first position, said receiver is disabled and said transmitter is enabled allowing contents of said portable address register to be transmitted to one of said address registers of one of said appliances, and wherein when said switch is in said second position, said receiver is enabled and said transmitter is disabled allowing the portable device to accept identification information from one of said appliances into said portable address register.

14. A home automation system comprising:
a plurality of smart appliances, each of said smart appliances respectively having an address register for containing identification information;
a plurality of inductive transceivers each respectively connected to one of said address registers; and
a portable inductive data holder having a portable address register which is preprogrammed at manufacture with an identification code in said portable address register, said portable inductive data holder adapted to be placed near said inductive transceivers one at a time,
wherein said pre-programmed identification information is inductively transmittable to at least one of said address registers of said appliances, thereby making said appliances have the same identification information.

15. A method of maintaining the identity of constituent smart appliances each respectively having address registers in a home automation system, comprising the steps of:
providing a plurality of inductive transceivers respectively connected to the address registers of the smart appliances;
providing a portable inductive data holder having a portable address register;
placing the portable data holder near one of the inductive transceivers; and
inductively transmitting the identification information of the first appliance into the portable address register of the portable inductive data holder.

16. A method according to claim 15, further comprising the step of inductively transmitting the identification information received into the portable address register to an address register of a second appliance.

17. A method according to claim 16, the portable inductive data holder having a first end, a second end, a receiver, and a transmitter, the method further comprising the steps of:
providing the receiver in the first end of the portable inductive data holder connected to the portable address register; and
providing the transmitter in the second end houses said transmitter connected to the portable address register.

18. A method according to claim 17, further comprising the steps of:
bringing the first end close to the induction transceiver of an appliance to initiate inductive transmission of identification information from the inductive transmitter to the receiver and thereby dispose the identification information in the portable address register; and
bringing the second end close to the induction receiver of the appliance to initiate inductive transmission of identification information from the portable address register to an address register of another appliance via the transmitter and the inductive transceiver and thereby dispose the identification code in the address register of the other appliance.

19. A method according to claim 16, the portable inductive data holder further being provided with a receiver, a transmitter, and a switch connected to the receiver and the transmitter movable from a first position to a second position for switching between a receiving mode and a transmitting mode, further comprising the steps of:
moving the switch into the first position to disable the receiver and to enable the transmitter allowing contents of the portable address register to be transmitted to an appliance; and
moving the switch into the second position to enable the receiver and to disable the transmitter allowing the portable device to accept identification information from an appliance into the portable address register.

20. A method of maintaining the identity of constituent smart appliances each respectively having address registers in a home automation system, comprising the steps of:
providing a plurality of inductive transceivers respectively connected to the address registers of the smart appliances;
providing a portable inductive data holder having a portable address register;
pre-programming said portable address register at manufacture with an identification code;
placing the portable data holder near each of the inductive transceivers; and
inductively transmitting the pre-programmed identification code into each of the address registers of the appliances.
